(19) United States
(12) Patent Application Publication
(10) Pub. No.: US 2021/0165540 A1
(43) Pub. Date: Jun. 3, 2021

(54) INFORMATION PROCESSING DEVICE, INFORMATION PROCESSING METHOD, AND PROGRAM

(71) Applicant: Sony Corporation, Tokyo (JP)

(72) Inventors: Kazunori Araki, Tokyo (JP); Shimon Sakai, Kanagawa (JP)

(73) Assignee: Sony Corporation, Tokyo (JP)

(21) Appl. No.: 17/259,509

(22) PCT Filed: May 23, 2019
(86) PCT No.: PCT/JP2019/020454

§ 371 Date: Jan. 11, 2021

(30) Foreign Application Priority Data
Jul. 18, 2018 (JP) 2018-134628

(51) Int. Cl. G06F 3/0482

(52) U.S. Cl. CPC G06F 3/0482; G10L 15/22

(57) ABSTRACT

An information processing device includes a designation generation unit that generates a plurality of designations based on an official name of a predetermined item, a selection unit that selects at least one designation in a case where the item is displayed as recommendation information, and a display control unit that displays the selected designation together with information indicating the item.

### TECHNICAL FIELD

The present disclosure relates to an information processing device, an information processing method, and a program.

### BACKGROUND ART

Among computer user interfaces, a natural user interface (NUI), which enables a user to operate with more natural or intuitive operations, has been receiving widespread attention in recent years. For example, Patent Document 1 below describes a device that predefines designations related to general objects and uses the defined designations to implement the NUI.

### CITATION LIST

### Patent Document

### Patent Document 1: Japanese Patent Application Laid-Open No. 2015-18365

### SUMMARY OF THE INVENTION

### Problems to be Solved by the Invention

For example, it is unclear what kind of designation is used to identify an object for which a general designation has not been established (hereinafter, appropriately referred to as a designation-undecided object), such as a newly completed facility or a little-known object. Therefore, if a designation for a designation-undecided object is created in advance on a device side, and a user is induced to use the designation, the designation-undecided object can be identified by the designation, which contributes to a more natural interaction between the user and the device.

One of the purposes of the present disclosure is to provide, for example, an information processing device, an information processing method, and a program that generate a designation corresponding to a designation-undecided object and present the generated designation.

### Solutions to Problems

The present disclosure is, for example,

an information processing device including

a designation generation unit that generates a plurality of designations based on an official name of a predetermined item,

a selection unit that selects at least one designation in a case where the item is displayed as recommendation information, and

a display control unit that displays the selected designation together with information indicating the item.

The present disclosure is, for example,

an information processing method including

generating, by a designation generation unit, a plurality of designations based on an official name of a predetermined item,

selecting, by a selection unit, at least one designation in a case where the item is displayed as recommendation information, and

displaying, by a display control unit, the selected designation together with information indicating the item.

The present disclosure is, for example,

a program that causes a computer to execute an information processing method including

generating, by a designation generation unit, a plurality of designations based on an official name of a predetermined item,

selecting, by a selection unit, at least one designation in a case where the item is displayed as recommendation information, and

displaying, by a display control unit, the selected designation together with information indicating the item.

### Effects of the Invention

According to at least an embodiment of the present disclosure, it is possible to generate a designation corresponding to a designation-undecided object and present the generated designation. Note that the effects described here are not necessarily limited, and may be any effects described in the present disclosure. In addition, the contents of the present disclosure are not to be construed as being limited by the exemplified effects.

### BRIEF DESCRIPTION OF DRAWINGS

FIG. 1 is a diagram for describing an outline of the present embodiment.

FIG. 2 is a diagram illustrating an example of a list screen displayed to a user.

FIG. 3 is a diagram for describing an example of an interaction transition between the user and an agent.

FIG. 4 is a block diagram for describing a configuration example of the agent according to the present embodiment.

FIGS. 5A and 5B are flowcharts for describing an example of a method of automatically assigning a designation to a designation-undecided object.

FIG. 6 is a diagram illustrating an example of registered contents of a designation DB.

FIGS. 7A and 7B are diagrams for describing a processing example in a case where one item is displayed as recommendation information.

FIG. 8 is a diagram for describing a processing example in a case where three items are displayed as the recommendation information.

FIG. 9 is a flowchart for describing the processing example in the case where three items are displayed as the recommendation information.

FIG. 10 is a diagram that is referred to when a specific example of processing performed to avoid overlap of designations is described.

FIG. 11 is a diagram that is referred to when a specific example of the processing performed to avoid overlap of designations is described.

FIG. 12 is a diagram for describing another specific example of the processing performed to avoid overlap of designations.

FIG. 13 is a diagram illustrating an example of the registered contents of the designation DB.

FIG. 14 is a diagram for describing an example of processing performed in a case where overlap of designations is unavoidable.

FIG. 15 is a diagram illustrating a display example in a case of displaying a plurality of designations corresponding to a predetermined item.

### MODE FOR CARRYING OUT THE INVENTION

Hereinafter, an embodiment and the like of the present disclosure will be described with reference to the drawings. Note that the description will be made in the following order.

### One Embodiment

### Modified Example

The embodiment and the like to be described below are preferred specific examples of the present disclosure, and the contents of the present disclosure are not limited to the embodiment and the like.

### One Embodiment

### Outline of One Embodiment

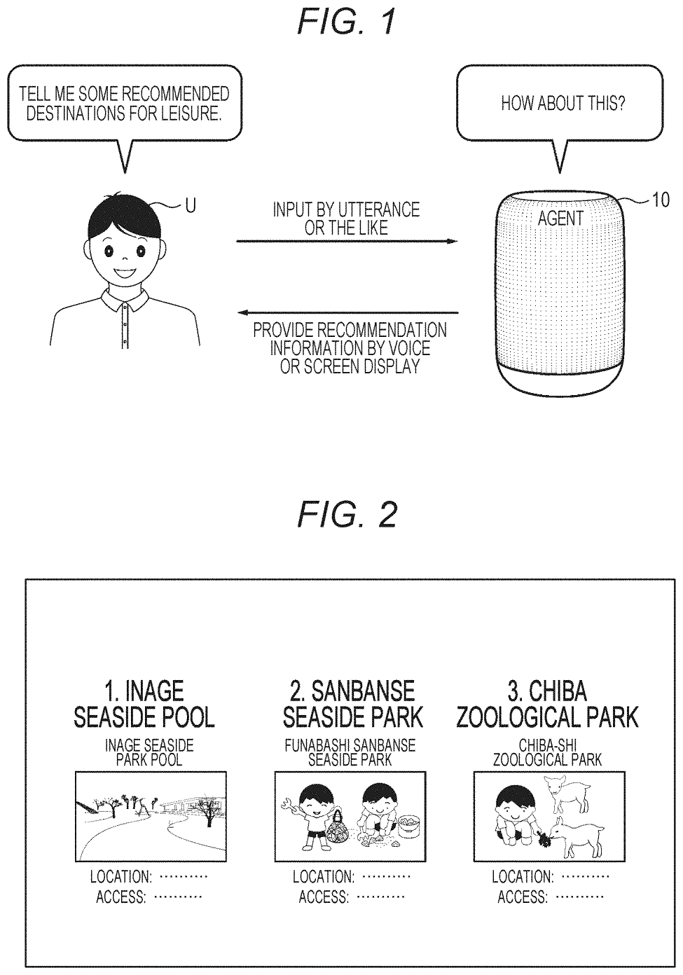

FIG. 1 is a diagram for describing an outline of the present embodiment. As illustrated in FIG. 1, a user U makes an input to an agent 10 that is an example of an information processing device, and the agent 10 presents, to the user U, results according to the input. Note that the agent means, for example, a voice input/output device having a portable size or a voice interaction function of the voice input/output device with a user. Such an agent is also referred to as a smart speaker or the like in some cases. Needless to say, the agent is not limited to the smart speaker, but may be a robot or the like, and does not have to be independent, but may be incorporated in various electronic devices such as smart phones, in-vehicle devices, and white goods.

In the present embodiment, the user U makes an input by an utterance to the agent 10. For example, the user U makes an utterance saying, “Tell me some recommended destinations for leisure”. The agent 10 to which the utterance is input searches information on the basis of a known method, and presents search results to the user U together with a voice such as “How about this?”, for example. The search results are presented by an appropriate method such as a voice or display. In the present embodiment, the search results are presented to the user U by projection display.

One or more items are displayed as the search results. In the present embodiment, the item will be described as a facility such as a park, a zoo, or an amusement park, but the present invention is not limited to this, and any item that meets a request of the user U may be used.

FIG. 2 is a diagram illustrating an example of the items displayed to the user U. In the example illustrated in FIG. 2, a plurality of items is displayed to the user U. Specifically, three items are displayed: “Inage Seaside Park Pool”, “Funabashi Sanbanse Seaside Park”, and “Chiba-Shi Zoological Park”. An official name of each item is displayed. The official name is a name given by a facility manager or the like (an author or the like in a case where the item is a book), and means a name that is not abbreviated. Below the official names, images corresponding to the items are displayed. Below the images, information indicating locations and access methods of the items are displayed.

Here, at least one of the three items is a designation-undecided object. For convenience of description, in the present embodiment, all the three items will be described as the designation-undecided objects. That is, each of the three items illustrated in FIG. 2 is an item for which a generally called abbreviation has not been established, or for which a plurality of generally called abbreviations exists. Generally, the official name includes a place or the like where the item exists, and thus the number of characters tends to be large. As the item becomes more well known, an abbreviation that makes it easier to call the item will be used. However, in a case of the designation-undecided object, there is no such abbreviation. Thus, even if the user U utters an arbitrary abbreviation, the abbreviation included in the utterance cannot be recognized by the agent 10, and there is a possibility that the item cannot be identified by the utterance.

Therefore, in the present embodiment, the agent 10 generates, in advance, such a designation that the user U can understand that the designation indicates the item, on the basis of the official name of the item. The agent 10 then displays the generated designation. In the example illustrated in FIG. 2, the designation is displayed above the official name. For example, the designation “Inage Seaside Pool” generated by the agent 10 is displayed above the official name “Inage Seaside Park Pool”. Furthermore, the designation “Sanbanse Seaside Park” generated by the agent 10 is displayed above the official name “Funabashi Sanbanse Seaside Park”. In addition, the designation “Chiba Zoological Park” generated by the agent 10 is displayed above the official name “Chiba-Shi Zoological Park”.

Note that, in the present embodiment, the designation generated by the agent 10 is displayed in an emphasized manner as compared with the official name. For example, a character size of the designation generated by the agent 10 is made larger than a character size of the official name. With such display, the user U can be induced to utter the designation generated by the agent 10.

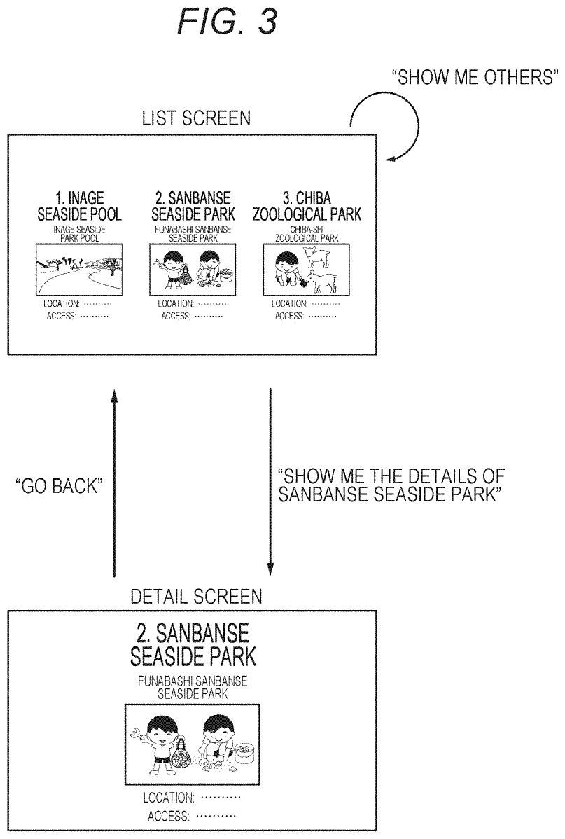

FIG. 3 is a diagram for describing an example of an interaction transition between the user U and the agent 10. In a case where the user U does not like the plurality of displayed items (see FIG. 2), the user U makes an utterance saying, for example, “Show me others”. In response to the utterance, the agent 10 searches for other items and displays search results. In addition, in a case where an item of interest to the user U exists among the plurality of displayed items, the user U specifies the item by utterance. Here, in the present embodiment, since the designation generated by the agent 10 is displayed in an emphasized manner as compared with the official name, it is possible to induce the user U to utter the designation.

For example, the user U makes an utterance saying, “Show me the details of Sanbanse Seaside Park”, including “Sanbanse Seaside Park”, which is the designation of “Funabashi Sanbanse Seaside Park”. Since “Sanbanse Seaside Park” is the designation generated by the agent 10, the agent 10 can identify information corresponding to “Sanbanse Seaside Park”, and can execute processing according to the result. For example, the agent 10 can display a detail screen including detailed information regarding “Sanbanse Seaside Park” as illustrated in FIG. 3. Note that, when the detail screen is displayed, the detailed information may be output by voice.

Note that, in a case where the user U wants to return displayed contents from the detail screen to a list screen where the plurality of items is displayed, the user U is only required to make an utterance saying, for example, “Go back”. The agent 10 to which the utterance is input performs processing of transitioning the displayed contents from the detail screen to the list screen.

As described above, in the present embodiment, the agent 10 generates a plurality of designations based on official names of a predetermined item. In addition, in a case where the item is presented as recommendation information, at least one designation is presented together with information indicating the item. By such processing of the agent 10, it is possible to induce the user U to specify the item by the presented designation. The user U can specify the item by using the designation that is easier to call than the official name. Furthermore, the agent 10 can identify an item corresponding to an uttered designation. Therefore, it is possible to prevent the agent 10 from erroneously recognizing the specified item as compared with a case where the user U specifies the item by an arbitrary designation. With the above outline in mind, the details of the present embodiment will be further described.

[About Agent]

(Configuration Example of Agent)

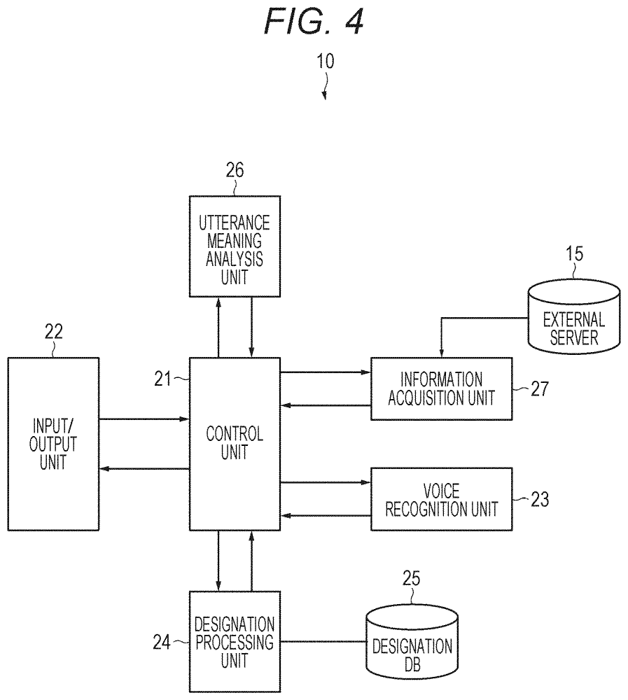

FIG. 4 is a block diagram for describing a configuration example of the agent 10 according to the present embodiment. The agent 10 includes, for example, a control unit 21, an input/output unit 22, a voice recognition unit 23, a designation processing unit 24, a designation database (DB) 25, an utterance meaning analysis unit 26, and an information acquisition unit 27.

The control unit 21 includes, for example, a central processing unit (CPU), and includes a read only memory (ROM) and a random access memory (RAM), which are not illustrated. The ROM stores a program executed by the control unit 21. The RAM is used as a work memory when the program is executed by the control unit 21, or is used as a memory that temporarily stores processing data. The control unit 21 controls an operation of the agent 10. For example, the control unit 21 functions as a display control unit that displays a designation selected by the designation processing unit 24 together with information indicating an item.

The input/output unit 22 is a general term for a configuration that receives an input from the user U and a configuration that outputs various information to the user U. Examples of the configuration that receives an input from the user U include a microphone for receiving an utterance, an input device for receiving an operation input such as a touch panel, a remote control device, or a button, an imaging device for detecting an operation by a gesture and a line-of-sight, and the like. Examples of the configuration that outputs various information to the user U include a speaker for outputting sounds, a display or a projection device for presenting information by display, a device for performing presentation by vibration or the like, and the like. Note that the configuration of the input/output unit 22 can be appropriately changed according to the function of the agent 10. The input/output unit 22 according to the present embodiment includes at least the microphone for receiving an utterance and the display for performing display (a projection display, a head up display (HUD), or the like may also be used).

The voice recognition unit 23 performs voice recognition by a known method for an utterance (voice) of the user U input via the input/output unit 22. The voice recognition unit 23 supplies a result of the voice recognition to the control unit 21.

The designation processing unit 24 generates a plurality of designations based on an official name of a predetermined item according to the control of the control unit 21. Furthermore, the designation processing unit 24 selects and reads at least one designation from the designation DB 25 in a case where the predetermined item is displayed as the recommendation information according to the control of the control unit 21. As described above, the designation processing unit 24 according to the present embodiment functions as a designation generation unit and a selection unit.

The designation processing unit 24 can access the designation DB 25. Examples of the designation DB 25 include, for example, a magnetic storage device such as hard disk drive (HDD), a semiconductor storage device, an optical storage device, an optical magnetic storage device, and the like. The designation DB 25 stores the designation generated by the designation processing unit 24 in association with the official name and the like. Note that a specific example of the information stored in the designation DB 25 will be described later.

The utterance meaning analysis unit 26 receives the result of the voice recognition by the voice recognition unit 23 via the control unit 21, and analyzes meaning of the utterance of the user U using the result of the voice recognition. For example, an intention and a target of the user U based on the utterance are analyzed by processing of the utterance meaning analysis unit 26.

The information acquisition unit 27 acquires information from an external server 15 existing on a network, a portable memory, or the like. A specific example of the information acquisition unit 27 can include a communication unit for connecting to a network such as the Internet. In this case, the information acquisition unit 27 includes a modulation/demodulation circuit, an antenna, and the like corresponding to a communication method. The communication may be wired communication or wireless communication. Examples of the wireless communication include a local area network (LAN), Bluetooth (registered trademark), Wi-Fi (registered trademark), a wireless USB (WUSB), and the like. The information acquisition unit 27 acquires various information. For example, the information acquisition unit 27 acquires information regarding newly opened facilities such as theme parks or stores, or new publications, detailed information regarding an item specified by the user U, and the like.

The configuration example of the agent 10 has been described above. Needless to say, the agent 10 may have a configuration other than the exemplified configuration. Furthermore, a part of the configuration of the agent 10 may be a configuration included in an external device different from the agent 10 (for example, a device on the cloud or a memory detachable from the agent 10).

(Operation Example of Agent)

Next, an operation example of the agent 10 will be described. For example, it is assumed that the user U makes an utterance saying, “Show me the details of Sanbanse Seaside Park (official name: Funabashi Sanbanse Seaside Park)”. Note that, as described above, Sanbanse Seaside Park is a designation displayed by the agent 10.

The utterance of the user U is input to the input/output unit 22, and voice data of the utterance is supplied to the voice recognition unit 23 via the control unit 21. The voice recognition unit 23 performs voice recognition based on the voice data. As a method of the voice recognition, a known method can be applied. As a result of the voice recognition, for example, a term (noun) “Sanbanse Seaside Park” is recognized.

The voice recognition unit 23 supplies the result of the voice recognition to the control unit 21. The control unit 21 supplies the result of the voice recognition to the designation processing unit 24. The designation processing unit 24 searches the designation DB 25 on the basis of the result of the voice recognition, and searches for an official name corresponding to “Sanbanse Seaside Park”. As a result of the search, it is determined that the official name corresponding to “Sanbanse Seaside Park” is “Funabashi Sanbanse Seaside Park”. The determination result is supplied to the control unit 21.

Meanwhile, the result of the voice recognition by the voice recognition unit 23 is supplied from the control unit 21 to the utterance meaning analysis unit 26. The utterance meaning analysis unit 26 analyzes an intention (domain goal) of the user U to “see the details” on the basis of the result of the voice recognition. The utterance meaning analysis unit 26 supplies the analysis result to the control unit 21.

The control unit 21 recognizes that the user U wants to “see the details of Funabashi Sanbanse Seaside Park” on the basis of the information supplied from the designation processing unit 24 and the utterance meaning analysis unit 26. The control unit 21 then controls the information acquisition unit 27 to acquire detailed information regarding Funabashi Sanbanse Seaside Park.

The control unit 21 displays the detailed information regarding Funabashi Sanbanse Seaside Park on the display of the input/output unit 22. The detailed information regarding Funabashi Sanbanse Seaside Park may be presented to the user U by voice.

[About Assigning Designation]

(Acquire Information regarding Item)

Next, processing of assigning a designation on the basis of an official name of a predetermined item will be described. Item information to be assigned a designation is acquired by, for example, the information acquisition unit 27. For example, the information acquisition unit 27 periodically searches information on the network, searches for characters such as “new opening”, “new store opening”, and “scheduled opening date”, recognizes an object which the characters are referring to as an item of a designation-undecided object, and acquires an official name of the item. Note that information regarding the item of the designation-undecided object may be purchased from a service provider.

As one method of assigning a designation to the item of the designation-undecided object, there is a method of manually assigning a designation. For example, a labeler (person) assigns a designation on the basis of the subjectivity and registers the designation. However, it is not realistic to manually assign designations to all designation-undecided objects. Therefore, it is preferable to automatically assign a designation to the designation-undecided object.

(Example of Method of Automatically Assigning Designation)

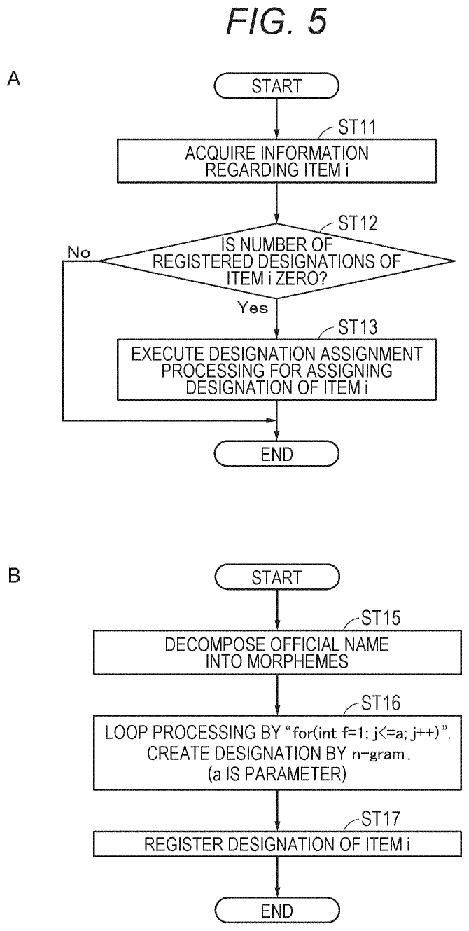

FIGS. 5A and 5B are flowcharts for describing an example of a method of automatically assigning a designation to the designation-undecided object. In step ST11, information regarding a predetermined item (item i) is acquired by the information acquisition unit 27. More specifically, an official name of the item i is acquired by the information acquisition unit 27. The official name of the acquired item i is supplied to the control unit 21. The processing then proceeds to step ST12.

In step ST12, the designation processing unit 24 searches for the presence or absence of a designation corresponding to the official name of the item i supplied from the information acquisition unit 27. Here, in a case where the number of registered designations of the item i is not zero, that is, in a case where the item i is not the designation-undecided object, it is not necessary to assign a designation, and thus the processing ends. In the determination processing of step ST12, in a case where the number of registered designations of the item i is zero, the processing proceeds to step ST13.

In step ST13, since the item i is the designation-undecided object, a designation assignment processing for assigning a designation of the item i is executed. The designation assignment processing is performed by the designation processing unit 24, for example, according to the control of the control unit 21.

FIG. 5B is a flowchart illustrating a flow of the designation assignment processing according to the present embodiment. In the designation assignment processing according to the present embodiment, the official name of the item i is morphologically analyzed, and the results are appropriately combined to generate a designation to be assigned. Note that, in order to make the description easier to understand, the official name of item i will be described below as “Funabashi Sanbanse Seaside Park”.

In step ST15, processing of decomposing the official name into morphemes is performed. By such processing, the official name “Funabashi Sanbanse Seaside Park” is decomposed into, for example, “Funabashi”, “Sanbanse”, “Seaside”, and “Park”. The processing then proceeds to step ST16.

In step ST16, the designation processing unit 24 generates designations by a method called n-gram. Such processing is looped by “for (int j=1; j<=a; j++)” (where a is a parameter).

For example, the designations are generated as follows:

in a case of j=1, “Funabashi”, “Sanbanse”, “Seaside”, and “Park”, and

in a case of j=2, “Funabashi Sanbanse”, “Sanbanse Seaside”, and “Seaside Park”. The designations are generated similarly for cases of j=3 or more.

The processing then proceeds to step ST17.

In step ST17, the designation processing unit 24 associates the generated designations related to the item i with predetermined information and registers the generated designations in the designation DB 25. Then, the processing ends.

Note that the method of assigning a designation to the item i is not limited to the above-described method, and a known method can be applied.

(Registered Contents of Designation DB 25)

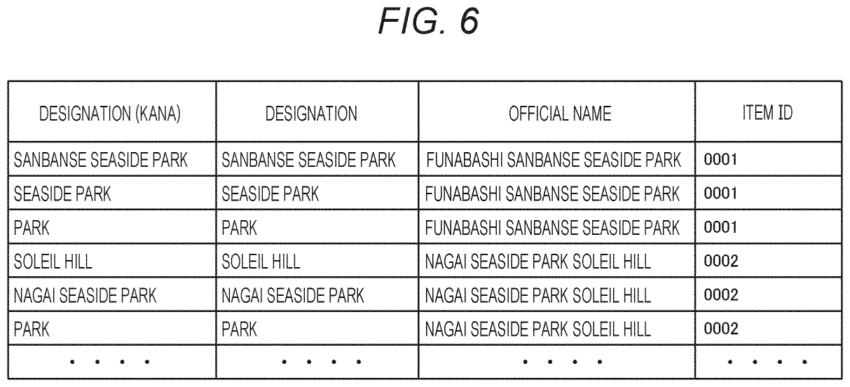

FIG. 6 is a diagram illustrating an example of registered contents of the designation DB 25. An item ID is associated with an official name of a predetermined item. For example, the official name “Funabashi Sanbanse Seaside Park” is associated with “0001” as the item ID. In addition, the official name “Nagai Seaside Park Soleil Hill” is associated with “0002” as the item ID.

Furthermore, a designation generated by the designation processing unit 24 is stored in the designation DB 25 in association with the official name and the item ID corresponding to the official name. For example, as illustrated in FIG. 6, the designation “Sanbanse Seaside Park” generated by the designation processing unit 24 is stored in association with the designation (kana) “Sanbanse Seaside Park”, the official name “Funabashi Sanbanse Seaside Park”, and the item ID “0001”.

[About Display of Designation]

Next, in a case where one or more items are displayed as the recommendation information to the user U, how to select and display the designation will be described. In the present embodiment, the recommendation information is displayed, for example, in response to an utterance of the user U to request to display the recommendation information. Needless to say, the recommendation information may be automatically displayed according to a state of the user U (resting state, or the like). Note that an algorithm regarding what kind of item is selected as the recommendation information is not limited to a specific one, and a known method can be applied.

(Case where One Item is Displayed as Recommendation Information)

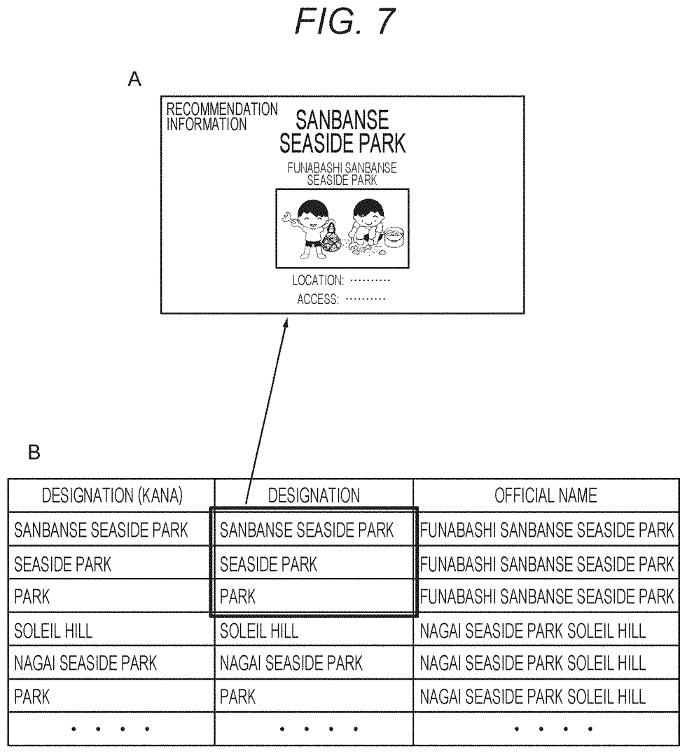

First, a case where one item is displayed as the recommendation information will be described. As illustrated in FIG. 7A, one item is displayed as the recommendation information. The item in this example is an item whose official name is “Funabashi Sanbanse Seaside Park”. The agent 10 displays the designations corresponding to the item. Here, as illustrated in FIG. 7B, the designation DB 25 stores “Sanbanse Seaside Park”, “Seaside Park”, and “Park” as designations corresponding to the official name “Funabashi Sanbanse Seaside Park”.

The designation processing unit 24 selects one of the designations “Sanbanse Seaside Park”, “Seaside Park” and “Park” corresponding to the official name “Funabashi Sanbanse Seaside Park”. The designation selected by the designation processing unit 24 is then displayed on the display under the control of the control unit 21.

The designation processing unit 24 randomly selects, for example, three designations. The designation processing unit 24 may select a designation having a length closest to the maximum number of characters that can be displayed on the display. If general names such as “Seaside Park” and “Park” are selected, the user U may feel that the user U has less choice to specifically select an item, and thus the designation processing unit 24 may select a designation that is not a general name (“Sanbanse Seaside Park”, in this example).

In a case where the user U wants detailed information regarding the displayed item, the user U is only required to make an utterance saying, “Show me the details of Sanbanse Seaside Park” or the like, using the displayed designation. In a case where the user U wants to check another item as the recommendation information, the user U is only required to make an utterance saying, “Show me other information” or the like. Note that, in the present embodiment, the official name is displayed together with the designation. Therefore, there is a possibility that the user U may make an utterance using the official name. Therefore, in the present embodiment, even in a case where the utterance using the official name is input, processing is performed similarly to processing in a case where the utterance using the designation is input.

(Case where Plurality of Items is Displayed as Recommendation Information)

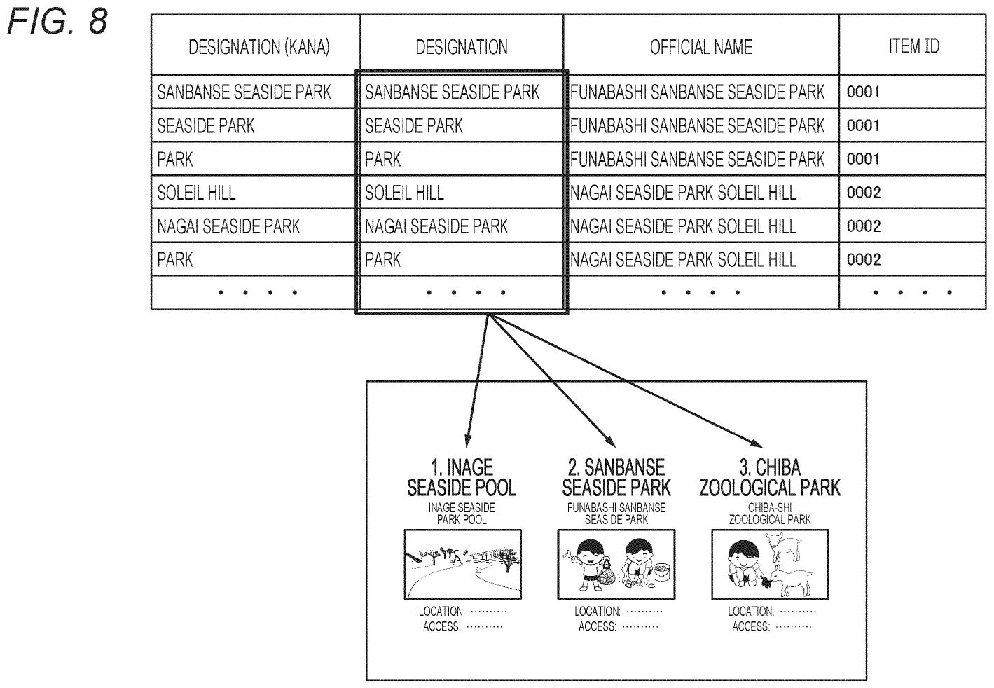

Next, a case where a plurality of items is displayed as the recommendation information will be described. As illustrated in FIG. 8, information regarding the plurality of items, for example, three items, is displayed at the same time. In addition, a designation selected by the designation processing unit 24 for each item is displayed together with information or the like indicating the item (for example, a thumbnail image). In the case where the plurality of items is displayed as the recommendation information, the designation processing unit 24 selects a designation associated with a corresponding item so that the each item can be identified by the designation associated with the corresponding item.

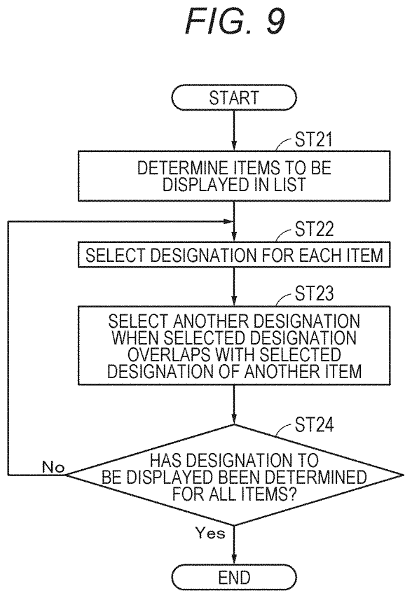

FIG. 9 is a flowchart for describing a processing example in the case where the plurality of (for example, three) items is displayed as the recommendation information. In step ST21, the control unit 21 determines the plurality of items to be displayed in a list in response to, for example, an input by an utterance of the user U. The processing then proceeds to step ST22.

In step ST22, the designation processing unit 24 selects, for each item, a designation corresponding to an official name of the item determined by the control unit 21. The designation processing unit 24 may select the highest-ranked designation from among designations corresponding to an item ID, or may randomly select a designation from among a plurality of designations corresponding to a predetermined official name. The processing then proceeds to step ST23.

Here, in a case where the plurality of items is displayed as the recommendation information at the same time, it is necessary to prevent overlapping designations (matched designations) from being displayed, unlike the case where only one item is displayed. This is because if the overlapping designations are displayed, an item corresponding to the designation cannot be identified even when the user U makes an utterance using the designation.

Therefore, in step ST23, in a case where a character string of a designation corresponding to a predetermined item (the designation selected by the designation processing unit 24) overlaps with that of a selected designation of another item, another designation different from the selected designation is selected. Such processing is performed by, for example, the designation processing unit 24. The processing then proceeds to step ST24.

In step ST24, for example, the control unit 21 determines whether or not the designation to be displayed has been determined for all the items. As a result of the determination, in a case where the designation to be displayed has not been determined for all the items, the processing returns to step ST22, and the processing in and after step ST22 is repeated. As a result of the determination, in a case where the designation to be displayed has been determined for all the items, the processing ends.

(Specific Example of Processing Performed to Avoid Overlap of Designations)

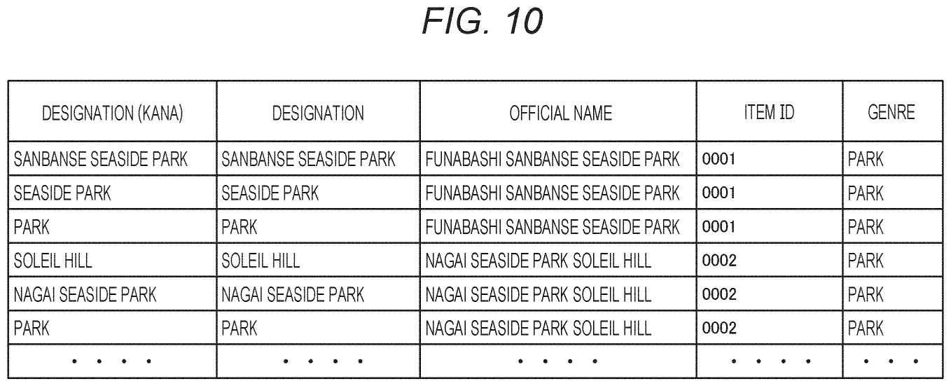

Next, a specific example of processing performed to avoid overlap of designations will be described. FIG. 10 illustrates an example of the information stored in the designation DB 25. In this example, unlike the above-described information stored in the designation DB 25 (see FIG. 6), each official name is further associated with a genre as attribute information. For example, the official name “Funabashi Sanbanse Seaside Park” is associated with “Park” as the genre. Similarly, the official name “Nagai Seaside Park Soleil Hill” is also associated with “Park” as the genre.

Here, it is assumed that information regarding “Funabashi Sanbanse Seaside Park” and “Nagai Seaside Park Soleil Hill” belonging to the same genre is displayed as the recommendation information. As illustrated in FIG. 10, selectable designations for “Funabashi Sanbanse Seaside Park” (item ID=0001) are “Sanbanse Seaside Park”, “Seaside Park”, and “Park”. In addition, selectable designations for “Nagai Seaside Park Soleil Hill” (item ID=0002) are “Soleil Hill”, “Nagai Seaside Park, and “Park”. In this case, the designation processing unit 24 selects designations so that a designation selected for “Funabashi Sanbanse Seaside Park” and a designation selected for “Nagai Seaside Park Soleil Hill” do not overlap. For example, the designation processing unit 24 selects a designation having the largest number of characters from among the plurality of selectable designations. This is because, in a case where the genres are the same, characteristics of the names are similar, and a longer designation is more likely to make characteristics of each item stand out, that is, the possibility that the selected designations will overlap (the possibility of matching) is extremely low.

Furthermore, the designation processing unit 24 selects, for example, the designation having the largest number of characters from among the plurality of selectable designations for a certain item. Then, the designation processing unit 24 may select, for another item, a designation whose difference in the number of characters from the selected designation is within a predetermined number of characters (for example, within five characters). A similar effect can be obtained by such selection.

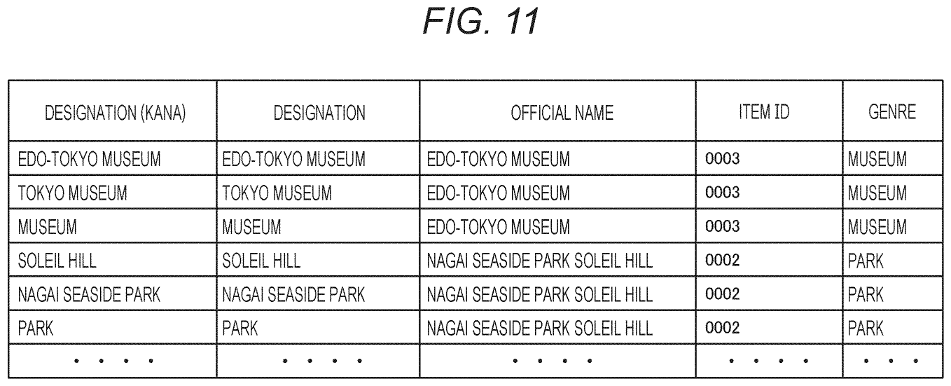

Meanwhile, as illustrated in FIG. 11, genres corresponding to official names may be different. For example, the official name “Edo-Tokyo Museum” is associated with the genre “Museum”. In addition, the official name “Nagai Seaside Park Soleil Hill” is associated with the genre “Park”. In a case where the genres are different, characteristics of the names are often different, and thus it is unlikely that selected designations will overlap. Therefore, in the case where items of different genres are displayed as the recommendation information, it is possible to select designations corresponding to the items by an appropriate method without being restricted by the number of characters or the like.

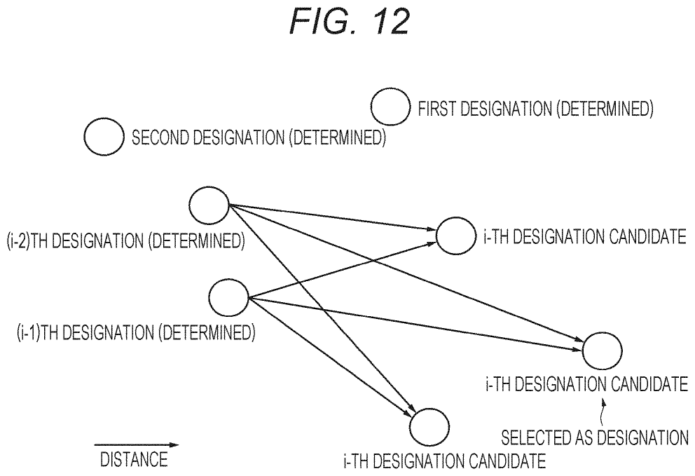

Another specific example of the processing performed to avoid overlap of designations will be described with reference to FIG. 12. In this example, when a new designation is selected, a designation having a low similarity to an already selected designation (similarity is smaller than a predetermined similarity) is selected. As a general measure of the similarity, a linguistic distance called Levenshtein distance or Jaro-Winkler distance can be used.

As an example, designations are selected as follows.

A designation of a first item is randomly selected from among designations corresponding to an official name of the item.

As a designation of a second item, a designation with the maximum distance from the designation selected for the first item is selected.

As a designation of a third item, a designation with the maximum average distance from the designations selected for the first and second items is selected.

After that, a designation is selected in a similar manner.

As described above, in this example, as schematically illustrated in FIG. 12, in a case where a designation of an i-th item is selected, a designation whose average distance from designations selected up to an (i−1)th item is maximized is selected. By performing such processing, it is possible to prevent designations of items from overlapping.

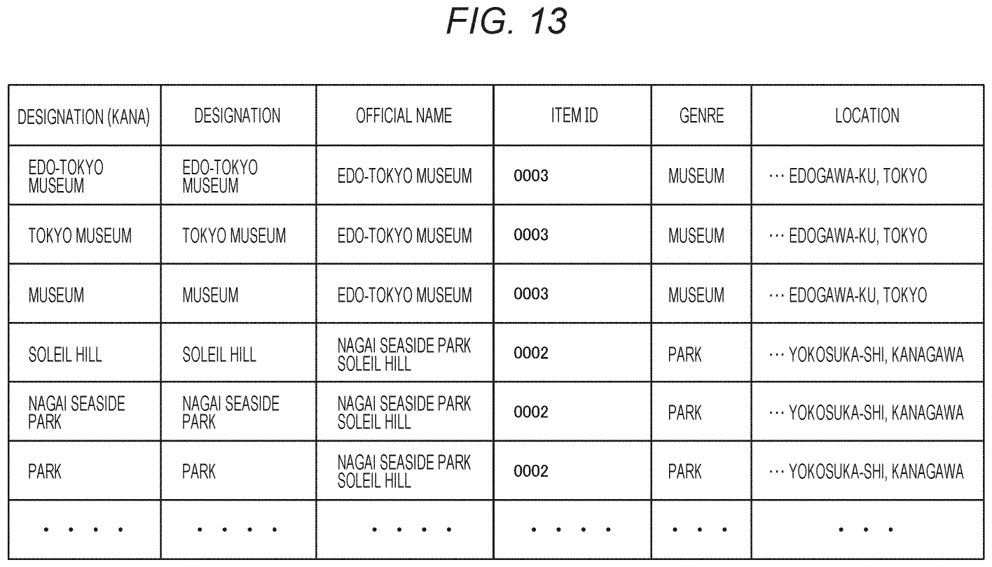

Another specific example of the processing performed to avoid overlap of designations will be described with reference to FIG. 13. FIG. 13 illustrates an example of the information stored in the designation DB 25. In this example, each official name is further associated with location information as the attribute information.

In this example, as a method of selecting a designation, information obtained via the network is referred to so that the designation is selected. For example, regarding “Nagai Seaside Park Soleil Hill”, from among “Soleil Hill”, “Nagai Seaside Park”, and “Park” which are candidates for the designation, one with a high appearance frequency may be selected as the designation on the basis of appearance frequencies or the like of words in blogs or the like on the Internet. However, since the designation “Park” or the like is a general name, the appearance frequency is high, and thus the possibility of being selected is high. If a general name is selected as the designation, designations may overlap, as described above. In consideration of this point, for example, in a case of presenting information regarding a vacation spot, a frequency of appearing at the same time as the location information is counted, and one with a high frequency is selected as the designation. Since many of the designations that appear together with the location information are not general names but are names including some information, it is possible to prevent a designation of a general name from being selected. Note that, in this example, since the vacation spot is displayed as the recommendation information, “Location” is associated with the official name, but information associated with the official name can be changed according to a type of information presented as the recommendation information or an application.

(Case where Overlap of Designations is Unavoidable)

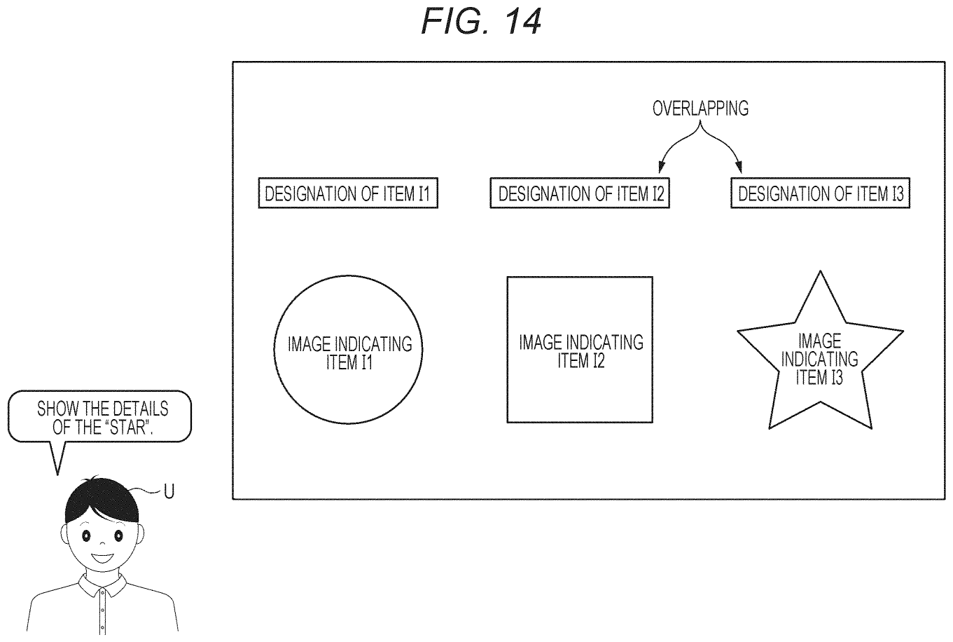

By performing the above-described processing, it is possible to prevent designations of displayed items from overlapping, but there are cases where overlap of the designations is unavoidable. Hereinafter, an example of processing performed in the case where overlapping of designations is unavoidable will be described with reference to FIG. 14.

As illustrated in FIG. 14, items I1 to I3 are selected as the recommendation information. Then, images indicating the items I1 to I3 are displayed, and designations each selected for a corresponding item are displayed. In the following, at least some of the three designations (a designation related to the item I1, a designation related to the item I2, and a designation related to the item I3) overlap. As a specific example, the description will be made assuming that the designation of the item I2 and the designation of the item I3 overlap.

If the overlapping designation is used, it is not possible to identify whether the item specified by the user U is the item I2 or the item I3. Therefore, in such a case, the control unit 21 displays selection information different from the designations together with information indicating each of the items I1 to I3. Here, the selection information is, for example, at least one of a color or a shape.

As a specific example, the images indicating the items are displayed so as to have different shapes. Specifically, the image of the item I1 is displayed in a circular shape. The image of the item I2 is displayed as a rectangular shape. The image of the item I3 is displayed in a star shape. Processing of changing the shapes of the images is performed by, for example, the control unit 21.

By displaying the selection information, it is possible to specify the item from a viewpoint different from the designation. For example, in a case where the user U wants to obtain detailed information regarding the item I3, the user U is only required to make an utterance saying, “Show me the details of the star” or the like. As described above, even in the case where overlap of designations is unavoidable, the selection information is displayed so that the user U can accurately specify the item.

The agent 10 may make an output to prompt selection of the item based on the selection information. For example, the agent 10 may perform display or a voice output saying, “Please select an item by shape” or the like.

Note that, as the selection information, information that does not have any meaning included in displayed designations (designations of items IM1 to IM3, in this example) may be used. For example, an example is assumed in which “Akaishi Park” is included in the displayed designations (any of overlapping designations (designations of the items IM1 and IM2) or a designation not overlapping (designation of the item IM3)). In a case where the color is used as the selection information and “red” is used, the agent 10 may erroneously recognize “Akaishi Park” in a case where the user U makes an utterance saying, “Red”. In addition, an example is assumed in which “Marui Zoo” is included in the displayed designations. In a case where the shape is used as the selection information and a “round shape” is used, the agent 10 may erroneously recognize “Marui Zoo” in a case where the user U makes an utterance saying, “Round”.

Therefore, it is possible to prevent such erroneous recognition from occurring by using, as the selection information, the information that does not have any meaning included in the displayed designations. Specifically, “red” and “round shape” are not used as the selection information and, thereby, it is possible to prevent the above-described erroneous recognition from occurring.

(Display of Plurality of Designations Corresponding to Predetermined Item)

In the above-described examples, in the case where one or more items are displayed as the recommendation information, one designation corresponding to the item is displayed. However, a plurality of designations corresponding to the displayed item may be displayed.

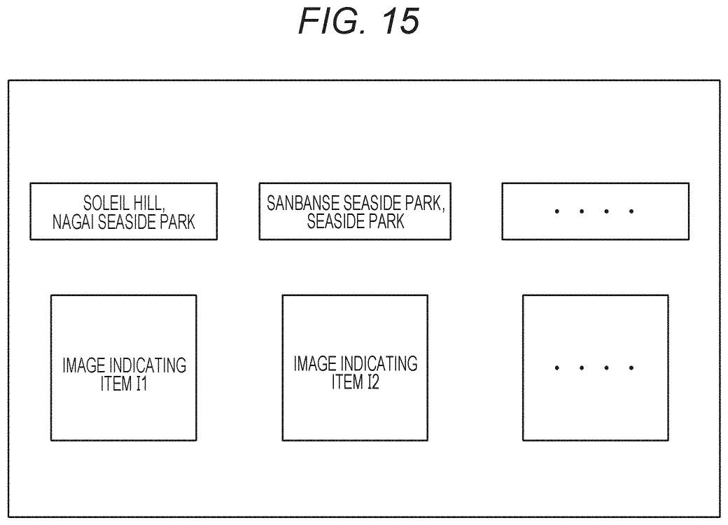

FIG. 15 is a diagram illustrating a display example in a case of displaying a plurality of designations corresponding to a predetermined item. In the display example illustrated in FIG. 15, the item I1 is “Nagai Seaside Park Soleil Hill” and the item I2 is “Funabashi Sanbanse Seaside Park”. As illustrated in FIG. 15, an image indicating the item I1 and an image indicating the item I2 are displayed side by side. In addition, above the image indicating each item, a plurality of designations corresponding to the item is displayed.

For example, “Soleil Hill” and “Nagai Seaside Park” are displayed as designations corresponding to the item I1. Furthermore, “Sanbanse Seaside Park” and “Seaside Park” are displayed as designations corresponding to the item I2.

Note that the displayed designations may be all of designation candidates corresponding to the items stored in the designation DB 25, or may be a part of the designation candidates. However, a designation overlapping with another item is not displayed. For example, “Park” exists as a designation candidate corresponding to the item I1, and “Park” also exists as a designation candidate corresponding to the item I2 (see FIG. 10). In this case, the designation processing unit 24 does not select the overlapping designation “Park” as the designation to be displayed.

As described above, by displaying a plurality of designations corresponding to a predetermined item, it is possible for the user U to select the item by use of a designation that the user U feels easy to utter. Note that, in the case of displaying the plurality of designations, for example, the agent 10 may determine a designation that is easy to utter, and display the designation that is easy to utter as a recommended designation. For example, the designation determined to be easy to utter may be displayed in an emphasized manner as compared with another designation. Examples of the emphasized display can include highlighting the designation that is easy to utter, increasing a font size of the designation that is easy to utter, movement of, for example, a dot-shaped user interface (UI) around an area of the designation that is easy to utter, and the like. The designation that is easy to utter is determined on the basis of, for example, the number of characters (specifically, the number of characters is within a predetermined number of characters), rhythm, or the like. Such determination is made by, for example, the control unit 21.

The embodiment of the present disclosure has been described above. According to the embodiment of the present disclosure, for example, even in a case where an item for which an established designation does not exist or an item whose designation is unclear is presented as the recommendation information, the agent can generate a designation corresponding to the item in advance and present the designation. Therefore, it is possible to induce the user to use the presented designation. When the user utters the designation presented by the agent, the agent can accurately recognize the item corresponding to the utterance. Furthermore, according to the present embodiment, it is possible to prevent a designation that cannot identify (cannot identify uniquely) the item specified by the user from being presented.

### Modified Example

Although a plurality of embodiments of the present disclosure has been specifically described above, the contents of the present disclosure are not limited to the above-described embodiments, and various modifications based on the technical idea of the present disclosure are possible. Hereinafter, a modified example will be described.

In the above-described embodiment, a mode in which an item is displayed as the recommendation information can be appropriately changed. For example, the number of items to be displayed in the list, presence or absence of images corresponding to the items on the list screen, displayed contents, a display order, and the like can be appropriately changed.

The configuration described in the above-described embodiment is merely an example, and the configuration is not limited to this. It goes without saying that addition, deletion, or the like of a configuration may be made without departing from the spirit of the present disclosure. The present disclosure can be implemented in any form such as a device, a method, a program, or a system. The program can be stored, for example, in a memory included in the control unit or an appropriate recording medium.

The present disclosure may adopt the following configurations.

(1)

An information processing device including:

a designation generation unit that generates a plurality of designations based on an official name of a predetermined item,

a selection unit that selects at least one designation in a case where the item is displayed as recommendation information, and

a display control unit that displays the selected designation together with information indicating the item.

(2)

The information processing device according to (1), in which

in a case where a plurality of items is displayed as the recommendation information, the selection unit selects a designation associated with a corresponding item so that each item is able to be identified by a designation associated with a corresponding item.

(3)

The information processing device according to (2), in which

the selection unit selects a designation so that a first designation corresponding to a first item and a second designation corresponding to a second item do not overlap.

(4)

The information processing device according to (3), in which

in a case where the first item and the second item belong to a same genre, the selection unit selects a designation so that the first designation and the second designation do not overlap.

(5)

The information processing device according to (3), in which

in a case where a designation different from the first designation is selected as a designation corresponding to the first item, the selection unit selects a designation having a lower degree of similarity to the first designation than a predetermined degree of similarity.

(6)

The information processing device according to any of (3) to (5), in which

in a case where overlap of the first designation and the second designation is unavoidable, the display control unit displays selection information different from a designation together with information indicating each of the first item and the second item.

(7)

The information processing device according to (6), in which

an output to prompt selection of an item based on the selection information is made.

(8)

The information processing device according to (6) or (7), in which

information that does not have any meaning included in the displayed designation is used as the selection information.

(9)

The information processing device according to any of (6) to (8), in which

the selection information is at least one of a color or a shape.

(10)

The information processing device according to any of (1) to (9), in which

the selection unit selects a designation by referring to information obtained via a network.

(11)

The information processing device according to any of (3) to (9), in which

the selection unit selects a plurality of first designations and a plurality of second designations, and

the display control unit displays the plurality of first designations and the plurality of second designations.

(12)

An information processing method including:

generating, by a designation generation unit, a plurality of designations based on an official name of a predetermined item;

selecting, by a selection unit, at least one designation in a case where the item is displayed as recommendation information; and

displaying, by a display control unit, the selected designation together with information indicating the item.

(13)

A program that causes a computer to execute an information processing method including:

generating, by a designation generation unit, a plurality of designations based on an official name of a predetermined item;

selecting, by a selection unit, at least one designation in a case where the item is displayed as recommendation information; and

displaying, by a display control unit, the selected designation together with information indicating the item.

### REFERENCE SIGNS LIST

10 Agent
21 Control unit
22 Input/output unit
24 Designation processing unit
26 Utterance meaning analysis unit
27 Information acquisition unit

1. An information processing device comprising:
a designation generation unit that generates a plurality of designations based on an official name of a predetermined item;
a selection unit that selects at least one designation in a case where the item is displayed as recommendation information; and
a display control unit that displays the selected designation together with information indicating the item.

2. The information processing device according to claim 1, wherein
in a case where a plurality of items is displayed as the recommendation information, the selection unit selects a designation associated with a corresponding item so that each item is able to be identified by a designation associated with a corresponding item.

3. The information processing device according to claim 2, wherein
the selection unit selects a designation so that a first designation corresponding to a first item and a second designation corresponding to a second item do not overlap.

4. The information processing device according to claim 3, wherein
in a case where the first item and the second item belong to a same genre, the selection unit selects a designation so that the first designation and the second designation do not overlap.

5. The information processing device according to claim 3, wherein
in a case where a designation different from the first designation is selected as a designation corresponding to the first item, the selection unit selects a designation having a lower degree of similarity to the first designation than a predetermined degree of similarity.

6. The information processing device according to claim 3, wherein
in a case where overlap of the first designation and the second designation is unavoidable, the display control unit displays selection information different from a designation together with information indicating each of the first item and the second item.

7. The information processing device according to claim 6, wherein
an output to prompt selection of an item based on the selection information is made.

8. The information processing device according to claim 6, wherein
information that does not have any meaning included in the displayed designation is used as the selection information.

9. The information processing device according to claim 6, wherein
the selection information is at least one of a color or a shape.

10. The information processing device according to claim 1, wherein
the selection unit selects a designation by referring to information obtained via a network.

11. The information processing device according to claim 3, wherein
the selection unit selects a plurality of first designations and a plurality of second designations, and
the display control unit displays the plurality of first designations and the plurality of second designations.

12. An information processing method comprising:
generating, by a designation generation unit, a plurality of designations based on an official name of a predetermined item;
selecting, by a selection unit, at least one designation in a case where the item is displayed as recommendation information; and
displaying, by a display control unit, the selected designation together with information indicating the item.

13. A program that causes a computer to execute an information processing method comprising:
generating, by a designation generation unit, a plurality of designations based on an official name of a predetermined item;
selecting, by a selection unit, at least one designation in a case where the item is displayed as recommendation information; and
displaying, by a display control unit, the selected designation together with information indicating the item.
